(19) United States
(12) Patent Application Publication
(10) Pub. No.: US 2023/0208028 A1
(43) Pub. Date: Jun. 29, 2023

(54) ANTENNA DEVICE, BEAMFORMING METHOD, AND NON-TRANSITORY COMPUTER READABLE STORAGE MEDIUM FOR PERFORMING BEAMFORMING

(71) Applicant: Panasonic Holdings Corporation, Osaka (JP)

(72) Inventors: Mikihiro OUCHI, Osaka (JP); Tomohiro KIMURA, Osaka (JP); Takayuki SOTOYAMA, Kanagawa (JP)

(21) Appl. No.: 18/063,627

(22) Filed: Dec. 8, 2022

(30) Foreign Application Priority Data
Dec. 23, 2021 (JP) 2021-209654

(51) Int. Cl. H01Q 3/28; H01Q 19/06

(52) U.S. Cl. CPC H01Q 3/28; H01Q 19/06

(57) ABSTRACT

An antenna device includes: an array feeder including antenna elements that are arrayed, the antenna elements being configured to radiate electromagnetic waves; and a lens that refracts the electromagnetic waves. The array feeder is configured to excite the antenna elements with complex excitation amplitudes at which the electromagnetic waves after being refracted by the lens travel as a plane wave in a desired direction, each of the antenna elements being excited with a corresponding one of the complex excitation amplitudes.

### BACKGROUND

### 1. Technical Field

The present disclosure relates to an antenna device, a beamforming method, and a non-transitory computer readable storage medium, and more particularly, to an antenna device, a beamforming method, and a non-transitory computer readable storage medium that are for performing beamforming.

### 2. Description of the Related Art

To commercialize a high-altitude platform station (HAPS), environmental improvement and technical development have progressed internationally, and thus its spread and expansion are expected. In particular, a stationary communication system using HAPS is highly expected to achieve securing of a redundant route of a backhaul line via the sky. In the World Radio Communication Conference in 2019 (WRC-19), an HAPS system with high-speed and large-capacity in cooperation with a 5G network in a 38 GHz band allocated to the HAPS was expected to be achieved (e.g., Suzuki et al. “Development of 38 GHz-band wireless communication system using high altitude platform (HAPS) for 5G Network-Study on broadband backhaul communication link for 5G network”, the Institute of Electronics, Information and Communication Engineers (IEICE) General Conference, 2021, B-3-1, March 2021). The HAPS flies while circling around the circumference in the stratosphere around an altitude of 20 km, and thus is required to be followed by performing beamforming to cause beams (radiation directivity characteristics) to be directed to a ground station. Then, the ground station is also required to follow the HAPS by performing beamforming to cause beams to be directed to the HAPS.

Considerable examples of an antenna device used for the ground station include an aperture antenna and a phased array antenna. The aperture antenna is roughly divided into a horn antenna using a waveguide, a parabolic antenna using reflection, a lens antenna using refraction, and the like. Although the aperture antenna easily forms a large aperture plane to constitute a high-gain antenna, the antenna device is required to be always mechanically driven to change its direction to follow the HAPS, and thus causing large power consumption for driving. In contrast, although the phased array antenna easily controls a direction of beams by controlling an excitation phase of its antenna element to follow the HAPS, many antenna elements are required to form a high gain antenna by increasing an aperture plane.

“Development of 38 GHz-band wireless communication system using high altitude platform station (HAPS) for 5G network - Examination of the 38 GHz-band ground station antenna for HAPS, Tsuji et al., The Institute of Electronics, Information and Communication Engineers (IEICE) General Conference in 2021, B-3-4, March 2021”, uses a system in which a lens antenna and an electronically controllable array feeder are combined, and the entire system is controlled by a machine drive gimbal, thereby suppressing side lobes for reducing interference with other radios and reducing power consumption during following control.

JP 2017-228856 A discloses an antenna device that includes a circular array for each mode of orbital angular momentum (OAM), the circular array being combined with a lens to allow each mode to have the same radiation angle of the maximum gain.

JP 2019-220995 A discloses an antenna system including multiple lens sets disposed in an array form, each lens set having a configuration in which one lens and multiple power feed elements are combined. Each lens set includes the power feed elements each having a different beam, and the antenna system performs coarser beam control by feeding power to corresponding power feed elements. The antenna system also performs precise beam control by controlling signals for feeding power to the power feed elements of the multiple lens sets.

JP 2014-143525 A discloses a design and manufacturing flow of a parabolic antenna mounted on a geostationary satellite for changing a radiation gain in a specific region at the time of rain attenuation or the like. The parabolic antenna and an array feeder are designed and manufactured so that a specific region can be changed in radiation gain by changing an excitation amplitude and a phase of the array feeder combined with the parabolic antenna. When the radiation gain in the specific region is changed due to rain attenuation or the like during operation after manufacturing, the radiation gain in the specific region is changed based on an excitation amplitude value and/or an excitation phase value instructed for each array element.

### SUMMARY

Unfortunately, the prior art described above has a room for improvement in that a method for generating a wavefront for improving a degree of freedom in designing the antenna device (the lens antenna or the parabolic antenna and the array feeder) is not shown in the combination.

Non-limiting examples of the present disclosure contribute to providing an antenna device and a beamforming method capable of improving a degree of freedom in designing a wavefront to be generated by an array feeder or a wavefront to be synthesized by an array receiver in a combination of a lens antenna or a parabolic antenna and the array feeder or the array receiver.

An antenna device according to an exemplary embodiment of the present disclosure includes: an array feeder including antenna elements that are arrayed, the antenna elements being configured to radiate electromagnetic waves; and a lens that refracts the electromagnetic waves. The array feeder is configured to excite the antenna elements with complex excitation amplitudes at which the electromagnetic waves after being refracted by the lens travel as a plane wave in a desired direction, each of the antenna elements being excited with a corresponding one of the complex excitation amplitudes.

An antenna device according to an exemplary embodiment of the present disclosure includes: an array receiver including antenna elements that are arrayed; and a lens that refracts electromagnetic waves that are incident, the lens being configured to irradiate the array receiver. The array receiver is configured to weight the antenna elements with complex amplitudes at which the electromagnetic waves before being refracted by the lens are incident on the lens as a plane wave from a desired direction, and is configured to combine wavefronts of the electromagnetic waves after being refracted by the lens.

An antenna device according to an exemplary embodiment of the present disclosure includes: an array feeder including antenna elements that are arrayed, the antenna elements being configured to radiate electromagnetic waves; and a reflector that reflects the electromagnetic waves. The array feeder is configured to excite the antenna elements with complex excitation amplitudes at which the electromagnetic waves after being reflected by the reflector travel as a plane wave in a desired direction.

An antenna device according to an exemplary embodiment of the present disclosure includes: an array receiver including antenna elements that are arrayed; and a reflector that reflects electromagnetic waves that are incident, the reflector being configured to irradiate the array receiver. The array receiver is configured to weight the antenna elements with complex amplitudes at which the electromagnetic waves before being reflected by the reflector are incident on the reflector as a plane wave from a desired direction, and is configured to combine wavefronts of the electromagnetic waves after being reflected by the reflector.

A beamforming method according to an exemplary embodiment of the present disclosure is performed by an antenna device including an array feeder and a lens, the array feeder including antenna elements that are arrayed. The beamforming method includes: exciting, by the array feeder, the antenna elements to radiate electromagnetic waves from the antenna elements, wherein the exciting includes exciting the antenna elements with complex excitation amplitudes at which the electromagnetic waves after being refracted by the lens travel as a plane wave in a desired direction.

A beamforming method according to an exemplary embodiment of the present disclosure is performed by an antenna device including an array receiver and a lens, the array receiver including antenna elements that are arrayed. The beamforming method includes: weighting, by the array receiver, the antenna elements with complex amplitudes at which electromagnetic waves before being refracted by the lens are incident on the lens as a plane wave from a desired direction, to combine wavefronts of the electromagnetic waves after being refracted by the lens.

A beamforming method according to an exemplary embodiment of the present disclosure is performed by an antenna device including an array feeder and a reflector, the array feeder including antenna elements that are arrayed. The beamforming method includes: exciting, by the array feeder, the antenna elements to radiate electromagnetic waves from the antenna elements, wherein the exciting includes exciting the antenna elements with complex excitation amplitudes at which the electromagnetic waves after being reflected by the reflector travel as a plane wave in a desired direction.

A beamforming method according to an exemplary embodiment of the present disclosure is performed by an antenna device including an array receiver and a reflector, the array receiver including antenna elements that are arrayed. The beamforming method includes: weighting, by the array receiver, the antenna elements with complex amplitudes at which electromagnetic waves before being reflected by the reflector are incident on the reflector as a plane wave from a desired direction, to combine wavefronts of the electromagnetic waves after being reflected by the reflector.

It should be noted that general or specific embodiments may be implemented as a system, a method, an integrated circuit, a computer program, a storage medium, or any selective combination thereof.

The array feeder according to an exemplary embodiment of the present disclosure excites the antenna elements with complex excitation amplitudes at which the electromagnetic waves after being refracted by the lens travel as a plane wave in a predetermined direction. As a result, beam shaping, which may also be referred to as beam forming, is performed so that power to be radiated falls within the lens. The beam shaping enables improving aperture efficiency and suppressing radiation to the outside of the lens, and thus enabling improvement in degree of freedom in designing a wavefront to be generated by the array feeder in a combination of the lens and the array feeder.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a basic configuration and basic operation of an antenna device according to a first exemplary embodiment of the present disclosure;

FIG. 2 is a diagram illustrating an example of a beam shifting method of an array feeder according to the first exemplary embodiment;

FIG. 3 is a diagram illustrating an example of details of the basic operation of the antenna device according to the first exemplary embodiment on the assumption of light focus characteristics of an ideal lens;

FIG. 4 is a diagram for illustrating an example of excitation amplitude of the array feeder according to the first exemplary embodiment;

FIG. 5 is a diagram for illustrating an example of wavefront shaping for the array feeder according to the first exemplary embodiment to perform beam shifting;

FIG. 6A is a diagram illustrating an example of an effect of wavefront shaping on aperture efficiency on a two-dimensional planar array according to the first exemplary embodiment;

FIG. 6B is a diagram illustrating an example of the effect of wavefront shaping on the aperture efficiency on the two-dimensional planar array according to the first exemplary embodiment;

FIG. 7 is a diagram illustrating an example of an effect of the wavefront shaping on improvement in degree of freedom of a focal length/diameter (F/D) ratio on the two-dimensional planar array according to the first exemplary embodiment;

FIG. 8 is a diagram illustrating an example of a configuration of the array feeder according to the first exemplary embodiment;

FIG. 9 is a diagram illustrating an example of a configuration of an array receiver according to the first exemplary embodiment for a reception function;

FIG. 10A is a diagram illustrating an example of an effect of displacing an array feeder from a focal plane of a lens according to a second exemplary embodiment of the present disclosure;

FIG. 10B is a diagram illustrating an example of the effect of displacing the array feeder from the focal plane of the lens according to the second exemplary embodiment of the present disclosure;

FIG. 11A is a diagram illustrating an example of the effect of displacing the array feeder from the focal plane of the lens according to the second exemplary embodiment of the present disclosure;

FIG. 11B is a diagram illustrating an example of the effect of displaceming the array feeder from the focal plane of the lens according to the second exemplary embodiment of the present disclosure; and

FIG. 12 is a diagram illustrating an example of a basic configuration and basic operation of an antenna device according to a third exemplary embodiment of the present disclosure.

### DETAILED DESCRIPTIONS

Hereinafter, exemplary embodiments of the present disclosure will be described in detail with reference to the drawings as appropriate. However, unnecessarily details may not be described. For example, details of already well-known matters and duplication of substantially identical configurations may not be described. This is to avoid unnecessary redundancy of description below and to facilitate understanding of those skilled in the art.

The accompanying drawings and the description below are provided for those skilled in the art to fully understand the present disclosure, and are not intended to limit the subject matter described in the scope of claims.

### First Exemplary Embodiment

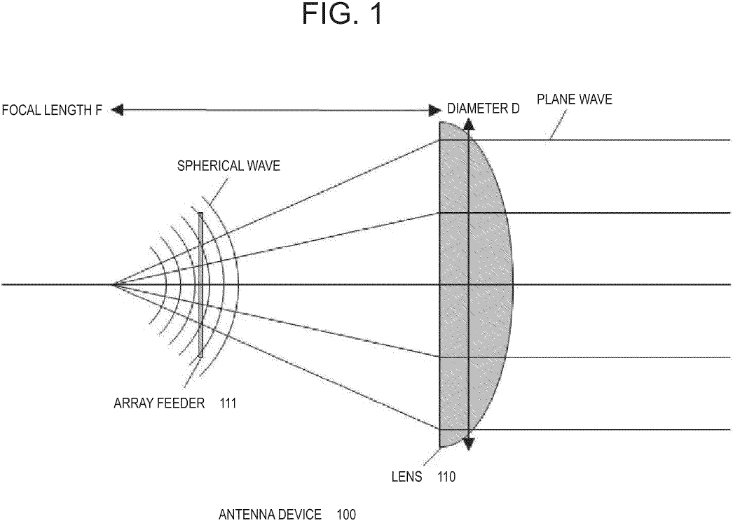

FIG. 1 is a diagram illustrating an example of a basic configuration and basic operation of antenna device 100 according to a first exemplary embodiment of the present disclosure. Antenna device 100 includes lens 110 and array feeder 111.

Lens 110 refracts an electromagnetic wave radiated by array feeder 111.

Array feeder 111 includes antenna elements that are two-dimensionally disposed to radiate electromagnetic waves, and generates and radiates a transmission beam (toward lens 110).

As illustrated in FIG. 1, examples of basic operation of array feeder 111 include generating a wavefront to be radiated from a virtual radiation position of lens 110, and performing beam shaping to cause radiated power to fall within lens 110.

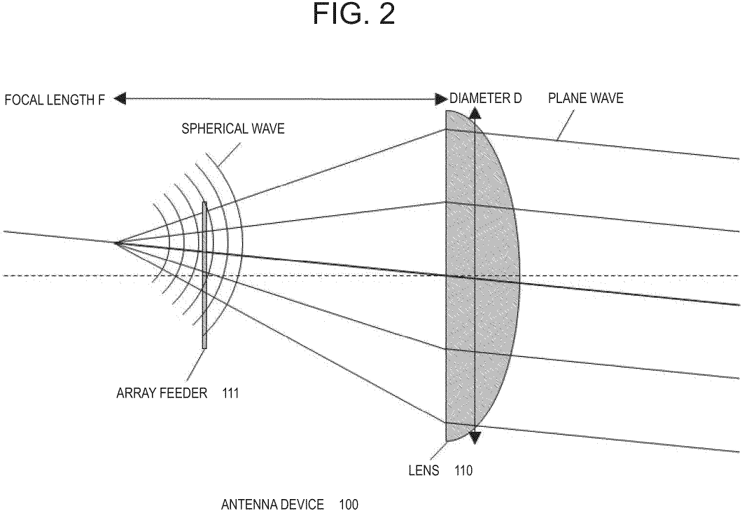

FIG. 2 is a diagram illustrating a beam shifting method of array feeder 111 in antenna device 100 according to the first exemplary embodiment.

Array feeder 111 achieves beam shifting by causing a controller (e.g., controller 129 to be described later) provided in array feeder 111 to control an excitation phase of the antenna element to generate a wavefront with a radiation position that is virtually shifted as illustrated in FIG. 2, and by performing beam shaping to cause the radiated power to fall within lens 110.

To describe below the principle of operation of antenna device 100, excitation amplitude of array feeder 111 will be first described assuming ideal light focus characteristics of a lens. Next, general lens characteristics will be described. Here, the ideal light focus characteristics refers to phase conversion characteristics in which a spherical wave emitted from a focal point is converted into a plane wave by passing through a lens. It is also assumed that the lens is a circular flat surface having no thickness, and causes no passing loss.

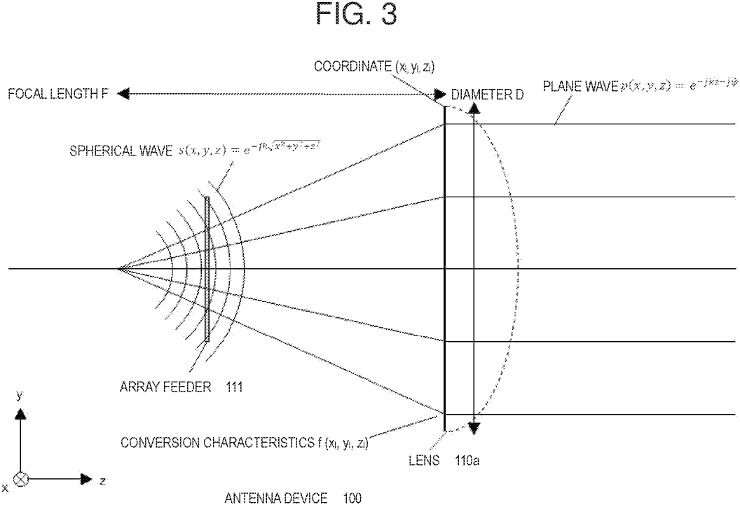

FIG. 3 is a diagram illustrating an example of details of basic operation of antenna device 100 on the assumption of light focus characteristics of an ideal lens in antenna device 100.

FIG. 3 illustrates lens 110a serving as a lens having ideal light focus characteristics. FIG. 3 illustrates an orthogonal coordinate system in which a focal point of lens 110a is set as an origin, a main axis of lens 110a is set as the z-axis, and a lens surface is disposed parallel to the x-y plane. The lens surface has coordinates (xl, yl, zl) that are expressed by Expression (1) where D is a diameter of the lens and F is a focal length.

### Expression 1

$${x}_{l} {}^{2} + {y}_{l} {}^{2} \leq {\left(\frac{D}{2}\right)}^{2} , {z}_{l} = F$$

Lens 110a refracts spherical wave s (x, y, z) emitted from the focal point and converts spherical wave s into plane wave p (x, y, z) traveling in the z-axis direction. Spherical wave s (x, y, z) and plane wave p (x, y, z) are expressed by Expressions (2) and (3), respectively.

### Expression 2

$$s \left(x , y , z\right) = {e}^{- j k \sqrt{{x}^{2} + {y}^{2} + {z}^{2}}}$$

### Expression 3

$$p \left(x , y , z\right) = {e}^{- j k z - j ψ}$$

where k is a wave number, and ψ is a phase delay.

Lens surface (xl, yl, zl) has conversion characteristics f (xl, yl, zl) of the lens that are expressed by Expression (4).

### Expression 4

$$f \left({x}_{l} , {y}_{l} , {z}_{l}\right) = \frac{p \left({x}_{l} , {y}_{l} , {z}_{l}\right)}{s \left({x}_{l} , {y}_{l} , {z}_{l}\right)} = {e}^{j k \sqrt{{x}_{l} {}^{2} + {y}_{l} {}^{2} + {z}_{l} {}^{2}} - j {z}_{l} - j ψ}$$

Here, the phase delay does not need to be considered, so that the term of the phase delay included in Expression (4) may be indicated as 0 as shown in Expression (5) and eliminated.

### Expression 5

$$- j {z}_{l} - j ψ = 0$$

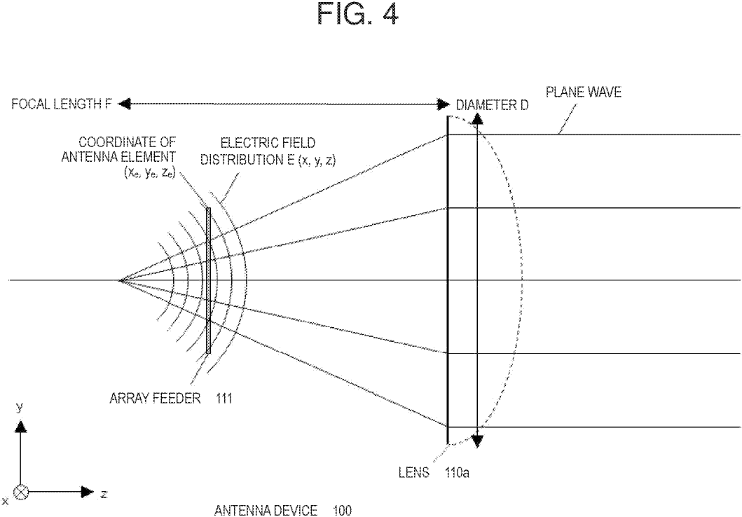

FIG. 4 is a diagram for illustrating the excitation amplitude of array feeder 111 in antenna device 100.

Available examples of array feeder 111 include a planar array antenna in which antenna elements are two-dimensionally disposed at equal intervals. One antenna element radiates an electromagnetic wave with electric field E (r, θ, (φ) that is expressed by Expression (6) using spherical coordinates.

### Expression 6

$$E \left(r , θ , ϕ\right) = {E}_{0} {g}_{e} \left(θ , ϕ\right) \frac{{e}^{- j k r}}{r} = {E}_{0} g \left(r , θ , ϕ\right)$$

where E₀ is complex excitation amplitude, gₑ (θ, (φ) is radiation directivity characteristics of the antenna element, and g (r, θ, (φ) is radiation directivity characteristics of the antenna element including attenuation due to distance and phase delay. Additionally, r is a radiation radius, 6 is a zenith angle from the z-axis, and φ is an azimuth angle with respect to the x-axis on the x-y plane. Radiation radius r, zenith angle θ, and azimuth angle φ are expressed by orthogonal coordinates (x, y, z) as Expressions (7), (8), and (9), respectively. The electric field of Expression (6) is also expressed as E (x, y, z) in the orthogonal coordinate system.

### Expression 7

$$r = \sqrt{{x}^{2} + {y}^{2} + {z}^{2}}$$

### Expression 8

$$θ = {tan}^{- 1} \frac{\sqrt{{x}^{2} + {y}^{2}}}{z}$$

### Expression 9

$$ϕ = {tan}^{- 1} \frac{y}{x}$$

The antenna element has complex excitation amplitude at position (xₑ, yₑ, _{Ze}), being expressed as E₀ (xₑ, yₑ, _{Ze}). Electric field E (x, y, z) at position (x, y, z) of the electromagnetic wave radiated from array feeder 111 is expressed as Expression (10) as a sum of electric fields of electromagnetic waves radiated from all antenna elements.

### Expression 10

$$E \left(x , y , z\right) = {\sum }_{{x}_{e} , {y}_{e} , {z}_{e}} {E}_{0} \left({x}_{e} , {y}_{e} , {z}_{e}\right) g \left(x - {x}_{e} , y - {y}_{e} , z - {z}_{e}\right)$$

The convolution operation of Expression (10) can be operated as a product of a Fourier domain, and thus Expression (10) can be transformed as Expression (11).

### Expression 11

$$F \left[E \left(x , y , z\right)\right] = F \left[{E}_{0} \left({x}_{e} , {y}_{e} , {z}_{e}\right)\right] F \left[g \left(x , y , z\right)\right]$$

where F[] is a Fourier transform.

To obtain a desired electric field distribution E (x, y, z) by array power feeding, array feeder 111 needs to acquire (or determines or calculates) E₀ (xₑ, yₑ, zₑ) of each antenna element according to Expression (12), and excite each antenna element with acquired E₀ (xₑ, yₑ, _{Ze}).

### Expression 12

$${E}_{0} \left({x}_{e} , {y}_{e} , {z}_{e}\right) = {F}^{- 1} \left[\frac{F \left[E \left(x , y , z\right)\right]}{F \left[g \left(x , y , z\right)\right]}\right]$$

where F⁻¹[] is an inverse Fourier transform. However, division is not preferable when F [g (x, y, z)] has a small value, so that complex excitation amplitude E₀ (xₑ, yₑ, _{Ze}) of each antenna element may be approximately acquired according to Expression (13).

### Expression 13

$${E}_{0} \left({x}_{e} , {y}_{e} , {z}_{e}\right) = {F}^{- 1} \left[F \left[E \left(x , y , z\right)\right] {\left(F \left[g \left(x , y , z\right)\right]\right)}^{∗}\right]$$

where ()* is a complex conjugate operation.

The operation described above may be performed by a controller (e.g., controller 129 described later) provided in array feeder 111, or may be performed by another functional unit.

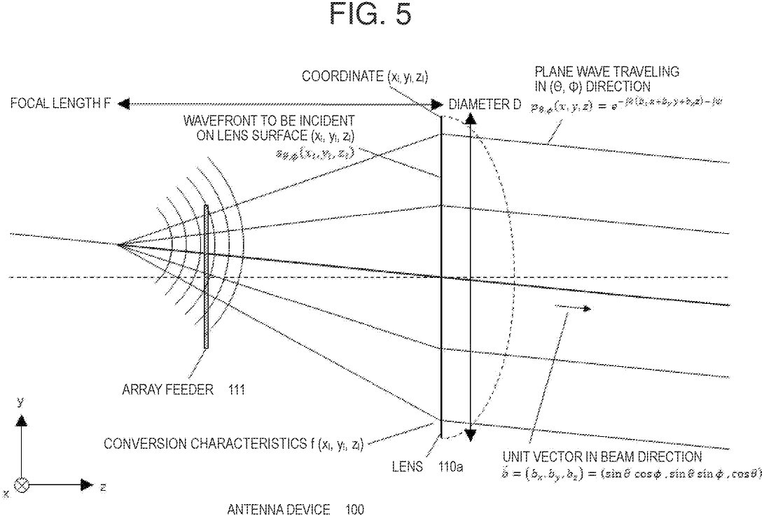

FIG. 5 is a diagram for illustrating wavefront shaping for array feeder 111 to perform beam shifting in antenna device 100.

As illustrated in FIG. 5, it is considered that beamforming is performed on a plane wave (beam) emitted from lens 110a in a (θ, (φ) direction. When a unit vector in a beam direction is expressed by Expression (14), the plane wave traveling in the (θ, (φ) direction can be expressed by Expression (16) or Expression (17) using a coordinate vector expressed by Expression (15).

### Expression 14

$$\vec{b} = \left({b}_{x} , {b}_{y} , {b}_{z}\right) = \left(sin θ cos ϕ , sin θ sin ϕ , cos θ\right)$$

### Expression 15

$$\vec{v} = \left(x , y , z\right)$$

### Expression 16

$${p}_{θ , ϕ} \left(\vec{v}\right) = {e}^{- j k \left(\vec{b} \vec{v}\right) - j ψ}$$

### Expression 17

$${p}_{θ , ϕ} \left(x , y , z\right) = {e}^{- j k \left({b}_{x} x + {b}_{y} y + {b}_{z} z\right) - j ψ}$$

where “.” is an inner product of vectors.

To radiate plane wave p_{θ},_{φ} (x₁, y₁, z₁) traveling in (θ, (φ) direction on lens surface (x₁, y₁, z₁), wavefront s_{θφ} (x₁, y₁, _{Z1}) expressed as Expression (18) needs to be incident on the lens.

### Expression 18

$${s}_{θ , ϕ} \left({x}_{l} , {y}_{l} , {z}_{l}\right) = \frac{{p}_{θ , ϕ} \left({x}_{l} , {y}_{l} , {z}_{l}\right)}{f \left({x}_{l} , {y}_{l} , {z}_{l}\right)}$$

To obtain incident wavefront s_{θ,φ} (x₁, y₁, z₁), array feeder 111 needs to excite each antenna element with complex excitation amplitude E₀ (xₑ, yₑ, _{Ze}) obtained by Expression (19). However, complex excitation amplitude E₀ (xₑ, yₑ, zₑ) obtained by Expression (19) is a relative value among the antenna elements, so that transmission power of each antenna element is desirably normalized to causes a sum of transmission powers of all the antenna elements to be predetermined transmission power.

### Expression 19

$${E}_{0} \left({x}_{e} , {y}_{e} , {z}_{e}\right) = {F}^{- 1} \left[F \left[{s}_{θ , ϕ} \left({x}_{l} , {y}_{l} , {z}_{l}\right)\right] {\left(F \left[g \left(x , y , z\right)\right]\right)}^{∗}\right]$$

The above is an example of details of the basic operation of antenna device 100 on the assumption of light focus characteristics of ideal lens 110a. General lens 110 having aberration and thickness can acquire corresponding complex excitation amplitude E₀ (xₑ, yₑ, _{Ze}) by a procedure such as calculating or measuring conversion characteristics f (x₁, y₁, z₁) of the lens in advance, or calculating or measuring desired wavefront characteristics s_{θ},_{φ} (x₁, y₁, z₁) on the incident plane (x₁, y₁, z₁) near an incident surface of lens 110 in advance.

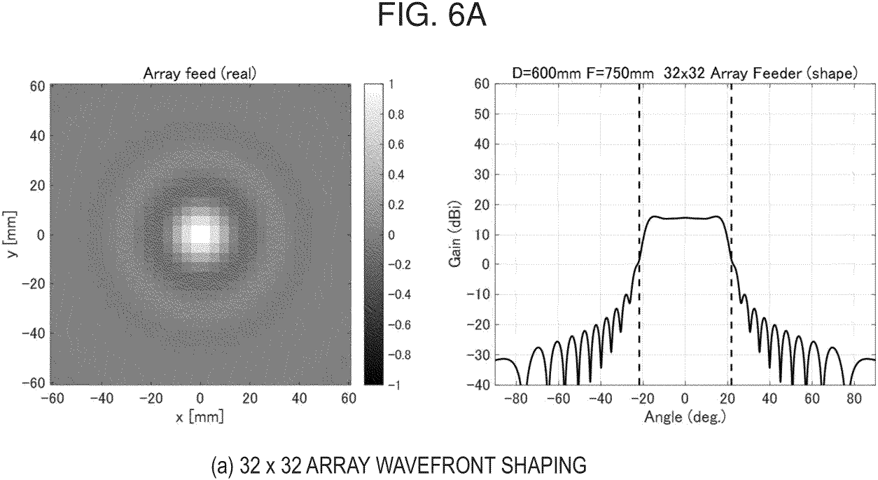

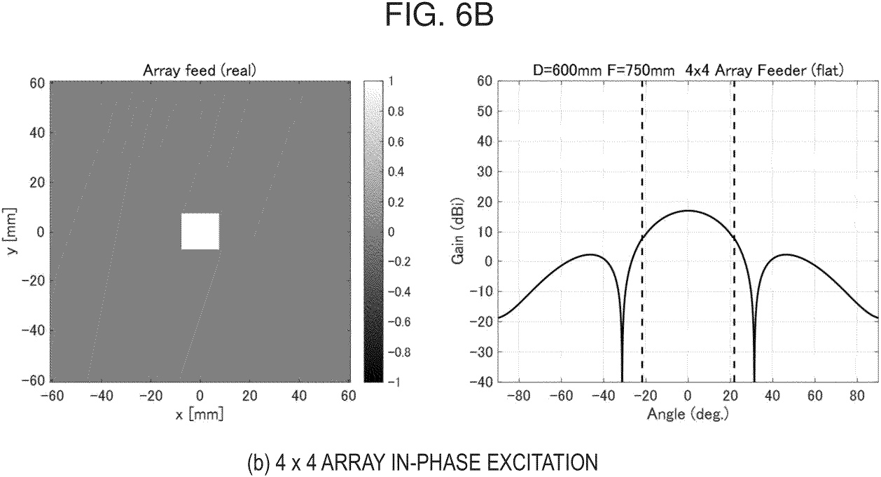

FIGS. 6A and 6B are each a diagram illustrating an example of an effect of wavefront shaping on aperture efficiency on a two-dimensional planar array (array feeder 111). This example uses a lens having diameter D of 600 mm, and focal length F of 750 mm.

FIG. 6A illustrates a two-dimensional planar array of 32 x 32 elements on which the above wavefront shaping is performed, and FIG. 6B illustrates a planar array of 4 x 4 elements on which excitation is performed at equal phase and equal amplitude without performing the above wavefront shaping.

FIGS. 6A and 6B each has a left side that represents an amplitude value of a real part of the complex excitation amplitude. FIGS. 6A and 6B each has a right side that represents radiation characteristics, and a broken line near ±20° represents positions of both ends of a lens diameter. FIGS. 6A and 6B reveal that performing the above wavefront shaping improves the aperture efficiency due to a high and flat gain within the lens diameter, thereby improving an antenna gain. FIGS. 6A and 6B also reveal that performing the above wavefront shaping suppresses unnecessary radiation to the outside of the lens.

As described above, appropriate control of the complex excitation amplitude at which the multiple antenna elements of array feeder 111 is excited in a combination of lens 110 and array feeder 111 enables a desired beam shape to be obtained in accordance with conversion characteristics of the lens, and tracking by beamforming to be performed. Additionally, an antenna gain can be improved, and unnecessary radiation can be suppressed.

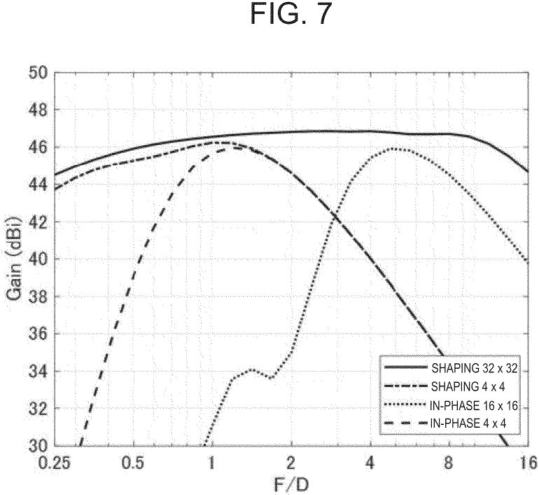

FIG. 7 is a diagram illustrating an example of an effect of the wavefront shaping on improvement in degree of freedom of a focal length/diameter (F/D) ratio on the two-dimensional planar array (array feeder 111).

As illustrated, the excitation performed at equal phase and equal amplitude without performing the wavefront shaping decreases a range of the F/D ratio in which a large gain is obtained, and the range varies depending on the number of antenna elements. In contrast, performing the wavefront shaping increases a range in which a large gain is obtained, and enables maintaining a high gain not only in a region with a small F/D ratio (i.e., antenna device 100 can be downsized), but also even in a region with a large F/D ratio particularly in a case where the number of antenna elements is large (in the case of 32 x 32 elements). The description above reveals that the wavefront shaping enables improvement in degree of freedom of the F/D ratio.

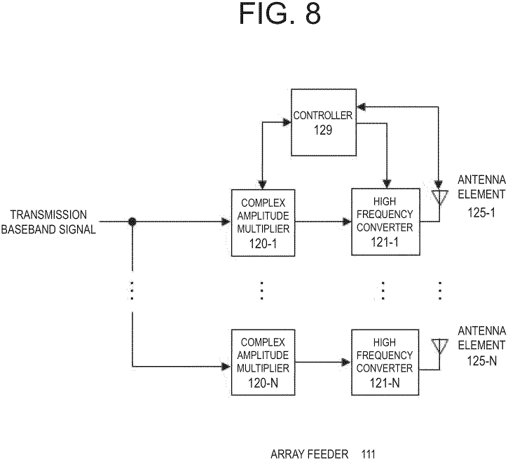

FIG. 8 is a diagram illustrating an example of a configuration of array feeder 111. Array feeder 111 includes N complex amplitude multipliers 120-1 to 120-N, N high frequency converters 121-1 to 121-N, N antenna elements 125-1 to 125-N, and controller 129. Complex amplitude multipliers 120-1 to 120-N may be referred to as complex amplitude excitation units 120-1 to 120-N, respectively.

Each of N complex amplitude multipliers 120-1 to 120-N multiplies a transmission baseband signal by complex excitation amplitude E₀ (xₑ, yₑ, _{Ze}) to radiate a plane wave pθ_{,φ} (x₁, y₁, z₁) traveling in the (θ, (φ) direction on lens surface (x₁, y₁, z₁), or the transmission baseband signal is excited with complex excitation amplitude E₀ (xₑ, yₑ, _{Ze}), and outputs the transmission baseband signal to N high frequency converters 121-1 to 121-N.

N high frequency converters 121-1 to 121-N convert the excited transmission baseband signals received from N complex amplitude multipliers 120-1 to 120-N, respectively, into high frequency signals to be transmitted, and output the high frequency signals to N antenna elements 125-1 to 125-N, respectively.

Controller 129 controls overall processing of array feeder 111. For example, controller 129 controls N complex amplitude multipliers 120-1 to 120-N, N high frequency converters 121-1 to 121-N, and N antenna elements 125-1 to 125-N to perform the processing described above. For example, controller 129 may control N complex amplitude multipliers 120-1 to 120-N, N high frequency converters 121-1 to 121-N, and N antenna elements 125-1 to 125-N to perform the processing described above by executing a program stored in a storage unit (not illustrated) such as a memory. In other words, such a program may cause controller 129 to control array feeder 111 including N antenna elements 135-1 to 135-N to perform the beamforming method according to the present disclosure. Controller 129 may also calculate complex excitation amplitude E₀ (xₑ, yₑ, _{Ze}) of each antenna element as described above.

In this manner, array feeder 111 controls a wavefront of an electromagnetic wave incident on lens 110 so that radiation characteristics of the electromagnetic wave refracted by lens 110 have a desired beam shape. Specifically, array feeder 111 excites N antenna elements 125-1 to 125-N with complex excitation amplitude E₀ (xₑ, yₑ, _{Ze}) at which the electromagnetic wave travels as a plane wave in a predetermined direction as a plane wave p_{θ},_{φ} (x₁, y₁, z₁) after being refracted by lens 110.

The above configuration enables providing antenna device 100 capable of improving degree of freedom in designing a wavefront to be generated by array feeder 111 in the combination of lens 110 and array feeder 111.

Although transmission functions of antenna device 100 are described above, reception functions of antenna device 100 can also be implemented on the same principle. Thus, antenna device 100 may further include array receiver 112.

Lens 110 refracts the incoming electromagnetic wave and irradiates array receiver 112 with the refracted electromagnetic wave.

Array receiver 112 includes antenna elements that are two-dimensionally disposed corresponding to array feeder 111 to receive the incoming electromagnetic wave refracted by lens 110.

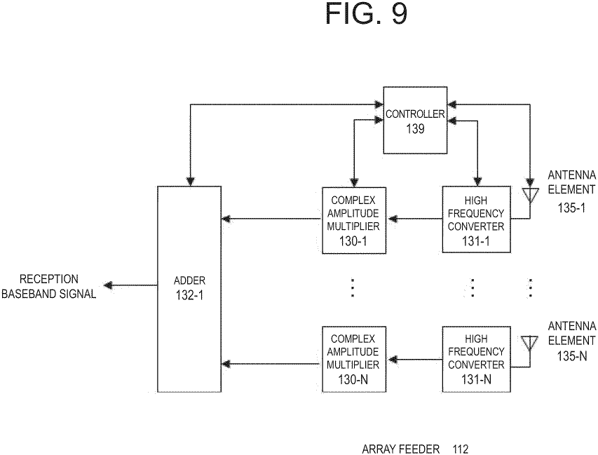

FIG. 9 is a diagram illustrating an example of a configuration of array receiver 112. Array receiver 112 includes N antenna elements 135-1 to 135-N, N high frequency converters 131-1 to 131-N, N complex amplitude multipliers 130-1 to 130-N, adder 132, and controller 139, corresponding to array feeder 111.

N antenna elements 135-1 to 135-N receive electromagnetic waves (high frequency signals) and output the electromagnetic waves to N high frequency converters 131-1 to 131-N, respectively.

N high frequency converters 131-1 to 131-N convert the high frequency signals received from N antenna elements 135-1 to 135-N, respectively, into baseband signals and output the baseband signals to N complex amplitude multipliers 130-1 to 130-N, respectively.

Each of N complex amplitude multipliers 130-1 to 130-N multiplies the baseband signal by complex amplitude E₀ (xₑ, yₑ, zₑ) to allow plane waves p_{θ,φ} (x₁, y₁, z₁) arriving from (θ, (φ) direction to be incident on lens surface (x₁, y₁, z₁), or multiplies the baseband signal by complex excitation amplitude E₀ (xₑ, yₑ, zₑ) in the transmission function, and outputs the baseband signal to adder 132.

Adder 132 adds multiplied N baseband signals received from N complex amplitude multipliers 130-1 to 130-N, or synthesizes wavefronts of the electromagnetic waves refracted by lens 110, thereby achieving desired wavefront characteristics s_{θ,φ} (x₁, y₁, z₁) in antenna elements 135-1 to 135-N.

Controller 139 controls overall processing of array receiver 112. For example, controller 139 controls N antenna elements 135-1 to 135-N, N high frequency converters 131-1 to 131-N, N complex amplitude multipliers 130-1 to 130-N, and adder 132 to perform the processing described above. For example, controller 139 may control N antenna elements 135-1 to 135-N, N high frequency converters 131-1 to 131-N, N complex amplitude multipliers 130-1 to 130-N, and adder 132 to perform the processing described above by executing a program stored in a storage unit (not illustrated) of antenna device 100, such as a memory. In other words, such a program may cause controller 139 to control array receiver 112 including N antenna elements 135-1 to 135-N to perform the beamforming method according to the present disclosure. Controller 139 may also calculate complex (excitation) amplitude E₀ (xₑ, yₑ, zₑ) of each antenna element as described above.

In this manner, array receiver 112 combines the wavefronts of the electromagnetic waves emitted from lens 110 so that reception characteristics of the electromagnetic waves before being refracted by lens 110 have a desired beam shape. Specifically, array receiver 112 combines the wavefronts of the electromagnetic waves after being refracted by lens 110 to allow the electromagnetic waves before being refracted by lens 110 to be incident on lens 110 as plane wave p_{θ,φ} (x₁, y_{1,} z₁) from a predetermined direction by weighting baseband signals received via N antenna elements 135-1 to 135-N with complex amplitude E₀ (xₑ, yₑ, _{Ze}),or by weighting N antenna elements 135-1 to 135-N with complex amplitude E₀ (xₑ, yₑ, zₑ) at which the electromagnetic waves before being refracted by lens 110 are incident on lens 110 as plane wave p_{θ,φ} (x₁, y₁, z₁) from the predetermined direction.

The above configuration enables providing antenna device 100 capable of improving degree of freedom in designing a wavefront to be synthesized by array receiver 112 in the combination of lens 110 and array receiver 112.

### Second Exemplary Embodiment

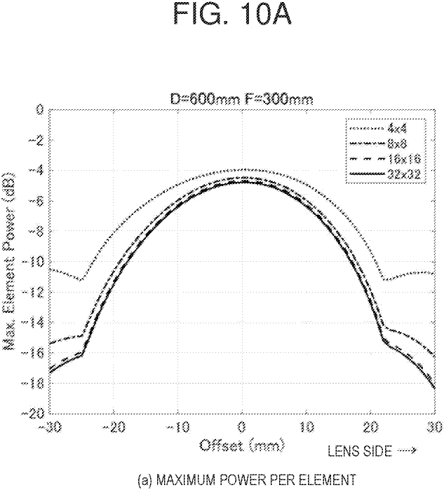

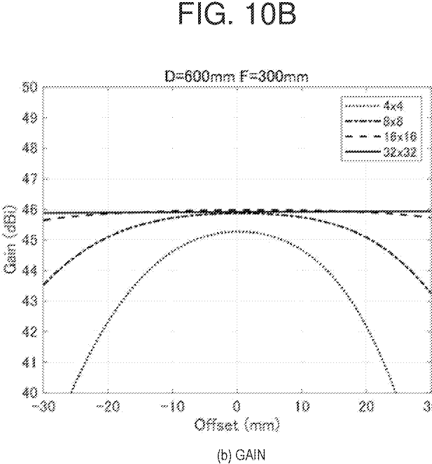

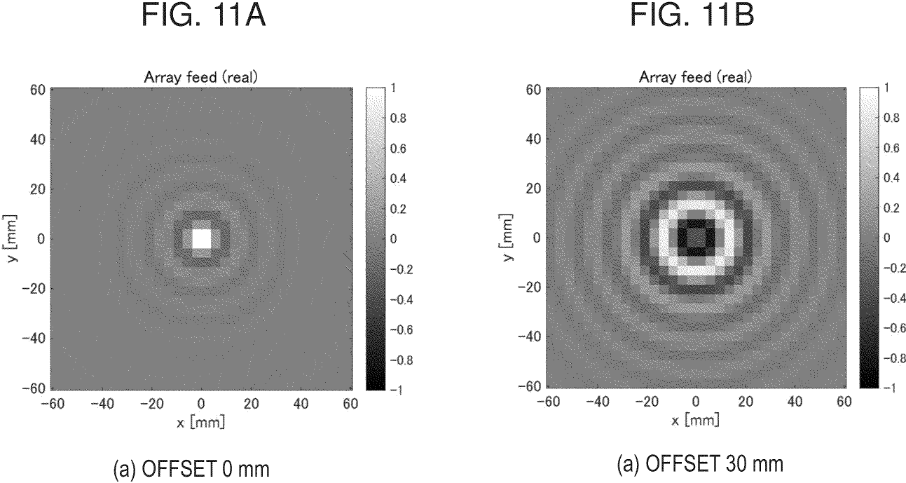

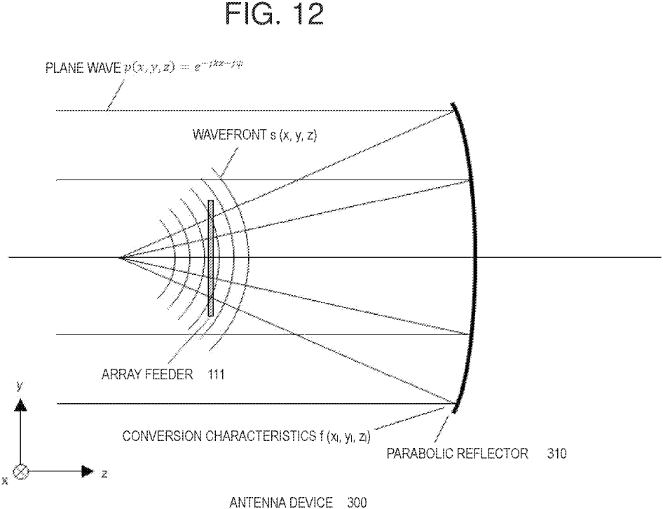

FIGS. 10A, 10B, 11A, and 11B are each a diagram illustrating an example of an effect when array feeder 111 is displaced from a focal plane of lens 110 in a two-dimensional planar array. This example uses lens 110 having diameter D of 600 mm, and focal length F of 300 mm.

FIG. 10A illustrates maximum power per element with respect to a sum of transmission power, and FIG. 10B illustrates gain. The present exemplary embodiment illustrates results only when wavefront shaping is performed. FIGS. 10A and 10B each have a horizontal axis representing positions where array feeder 111 is disposed. The horizontal axis includes 0 that represents array feeder 111 being disposed in the focal plane of lens 110, the right direction (positive direction) across 0, in which the array feeder is close to lens 110 from the focal plane of lens 110, and the left direction (negative direction) across 0, in which the array feeder is apart from lens 110 from the focal plane of lens 110.

FIG. 10A reveals that the maximum power per element can be reduced as array feeder 111 is displaced from the focal plane of lens 110 for each of numbers of antenna elements from “4x4” to “32x32”.

FIGS. 11A and 11B illustrate amplitude of array power feeding at 0 mm in the horizontal axis (offset value) of FIG. 10A and amplitude of array power feeding at 30 mm in the horizontal axis (offset value) of FIG. 10A, respectively. FIGS. 11A and 11B reveals a state where power is prevented from concentrating on some elements by displacing array feeder 111 from the focal plane of lens 110.

Then, FIG. 10B reveals that a range of offsets in which gain can be maintained varies depending on the number of antenna elements, and the range increases as the number of antenna elements increases.

As described above, displacing array feeder 111 from the focal plane of lens 110 enables providing antenna device 100 capable of preventing power from concentrating on some elements while maintaining gain in the combination of lens 110 and array feeder 111 by using processing as in the first exemplary embodiment.

Displacing array receiver 112 from the focal plane of lens 110 also enables providing antenna device 100 capable of preventing power from concentrating on some elements while maintaining gain in the combination of lens 110 and array receiver 112 by using processing as in the first exemplary embodiment.

### Third Exemplary Embodiment

FIG. 12 is a diagram illustrating an example of a basic configuration and basic operation of antenna device 300 according to a third exemplary embodiment of the present disclosure. Antenna device 300 is similar in configuration to antenna device 100 according to the first exemplary embodiment, and thus is not described about the same configuration. Antenna device 300 is configured as a parabolic antenna, and includes parabolic reflector 310 and array feeder 111.

Parabolic reflector 310 reflects an electromagnetic wave radiated by array feeder 111.

Array feeder 111 according to the present exemplary embodiment is the same as array feeder 111 according to the first exemplary embodiment. Array feeder 111 includes antenna elements that are two-dimensionally disposed to radiate electromagnetic waves, and generates and radiates a transmission beam (toward parabolic reflector 310 instead of lens 110).

Parabolic reflector 310 has conversion characteristics f (x₁, y₁, z₁) due to reflection, and converts wavefront s (x, y, z) generated by array feeder 111 into plane wave p (x, y, z) traveling in the z-axis direction.

As in the first exemplary embodiment, the present exemplary embodiment also causes array feeder 111 to control a wavefront of an electromagnetic wave to be incident on parabolic reflector 310 such that radiation characteristics of the electromagnetic wave after being reflected by parabolic reflector 310 have a desired beam shape. Specifically, array feeder 111 excites N antenna elements 125-1 to 125-N with complex excitation amplitude E₀ (xₑ, yₑ, zₑ) at which the electromagnetic wave travels as plane wave p_{θ,φ} (x₁, y₁, z₁) in a predetermined direction, such as a direction parallel to the z-axis, after being reflected by parabolic reflector 310.

Antenna device 300 may further include array receiver 112.

Parabolic reflector 310 reflects the incoming electromagnetic wave and irradiates array receiver 112 with the reflected electromagnetic wave.

Array receiver 112 according to the present exemplary embodiment is the same as array receiver 112 according to the first exemplary embodiment. Array receiver 112 includes antenna elements instead of lens 110, the antenna elements being two-dimensionally disposed to receive the incoming electromagnetic wave reflected by parabolic reflector 310.

As in the first exemplary embodiment, the present exemplary embodiment also causes array receiver 112 to combines a wavefront of an electromagnetic wave emitted from parabolic reflector 310 such that reception characteristics of the electromagnetic wave before being reflected by parabolic reflector 310 have a desired beam shape. Specifically, array receiver 112 combines the wavefront of the electromagnetic wave after being reflected by parabolic reflector 310 by weighting N antenna elements 135-1 to 135-N with complex amplitude E₀ (xₑ, yₑ, zₑ) at which the electromagnetic wave before being reflected by parabolic reflector 310 is incident on parabolic reflector 310 as plane wave p_{θ,φ} (xi, y₁, z₁) from a predetermined direction.

Thus, as in the first exemplary embodiment, the configuration of antenna device 300 illustrated in FIG. 12 enables providing antenna device 300 capable of improving degree of freedom in designing a wavefront to be generated by array feeder 111 in the combination of parabolic reflector 310 and array feeder 111. As in the first exemplary embodiment, antenna device 300 can be provided, the antenna device being capable of improving degree of freedom in designing a wavefront to be synthesized by array receiver 112 in the combination of parabolic reflector 310 and array receiver 112. As in the second exemplary embodiment, antenna device 300 can be provided, the antenna device being capable of preventing power from concentrating on some elements while maintaining gain in the combination of parabolic reflector 310 and array feeder 111. As in the second exemplary embodiment, antenna device 300 can be provided, the antenna device being capable of preventing power from concentrating on some elements while maintaining gain in the combination of parabolic reflector 310 and array receiver 112.

(1) Although the first to third exemplary embodiments are each configured with full digital beamforming as illustrated in FIG. 8, the present disclosure is not limited thereto, and may be configured with hybrid beamforming or full digital beamforming. Even this configuration enables acquiring an effect similar to that described above.

(2) Although the first to third exemplary embodiments are each described about an example in which array feeder 111 includes controller 129 and array receiver 112 includes controller 139, the present disclosure is not limited to this example. For example, instead of array feeder 111 including controller 129 and array receiver 112 including controller 139, antenna devices 100 and 300 each may include controller 129 and controller 139 outside array feeder 111 and array receiver 112. In this case, controller 129 and controller 139 may be an integrated controller. These controllers may be each a processor, for example.

(3) In the first to third exemplary embodiments, the notation “unit” used for each component may be replaced with another notation such as “circuit (circuitry)”, “assembly”, “device”, or “module”.

(4) The present disclosure may relate to implementation using hardware and software. The above exemplary embodiments may be implemented or executed by using a computing device (processor). The computing device or processor may be, for example, a main processor/general purpose processor, a digital signal processor (DSP), an application specific integrated circuit (ASIC), a field programmable gate array (FPGA), other programmable logic device, or the like. The above exemplary embodiments may be implemented or achieved by combining these devices.

(5) The first to third exemplary embodiments may be achieved by a software module mechanism executed by a processor or directly by hardware. Additionally, a software module and hardware implementation also can be combined. The software module may be stored on various types of computer-readable storage media, such as a random access memory (RAM), an erasable programmable read-only memory (EPROM), an electrically erasable programmable read-only memory (EEPROM), a flash memory, a register, a hard disk, a CD-ROM, a DVD, and the like.

### Summary of Exemplary Embodiments

An antenna device according to an exemplary embodiment of the present disclosure includes: an array feeder including antenna elements that are arrayed, the antenna elements being configured to radiate electromagnetic waves; and a lens that refracts the electromagnetic waves. The array feeder is configured to excite the antenna elements with complex excitation amplitudes at which the electromagnetic waves after being refracted by the lens travel as a plane wave in a desired direction, each of the antenna elements being excited with a corresponding one of the complex excitation amplitudes.

A beamforming method according to an exemplary embodiment of the present disclosure is performed by an antenna device including an array feeder and a lens, the array feeder including antenna elements that are arrayed. The beamforming method includes: exciting, by the array feeder, the antenna elements to radiate electromagnetic waves from the antenna elements, wherein the exciting includes exciting the antenna elements with complex excitation amplitudes at which the electromagnetic waves after being refracted by the lens travel as a plane wave in a desired direction.

The configuration described above allows the array feeder to excite the multiple antenna elements with complex excitation amplitudes at which the electromagnetic waves after being refracted by the lens travel as a plane wave in a desired direction. As a result, beam shaping is performed so that power to be radiated falls within the lens. The beam shaping enables improving aperture efficiency and suppressing radiation to the outside of the lens, and thus enabling improvement in degree of freedom in designing a wavefront to be generated by the array feeder in a combination of the lens and the array feeder.

An antenna device according to an exemplary embodiment of the present disclosure includes: an array feeder including antenna elements that are arrayed, the antenna elements being configured to radiate electromagnetic waves; and a reflector that reflects the electromagnetic waves. The array feeder is configured to excite the antenna elements with complex excitation amplitudes at which the electromagnetic waves after being reflected by the reflector travel as a plane wave in a desired direction.

A beamforming method according to an exemplary embodiment of the present disclosure is performed by an antenna device including an array feeder and a reflector, the array feeder including antenna elements that are arrayed. The beamforming method includes: exciting, by the array feeder, the antenna elements to radiate electromagnetic waves from the antenna elements, wherein the exciting includes exciting the antenna elements with complex excitation amplitudes at which the electromagnetic waves after being reflected by the reflector travel as a plane wave in a desired direction.

The configuration described above allows the array feeder to excite the multiple antenna elements with complex excitation amplitudes at which the electromagnetic waves after being reflected by the reflector travel as a plane wave in a desired direction. As a result, beam shaping is performed so that power to be radiated falls within the reflector. The beam shaping enables improving aperture efficiency and suppressing radiation to the outside of the reflector, and thus enabling improvement in degree of freedom in designing a wavefront to be generated by the array feeder in a combination of the reflector and the array feeder.

An antenna device according to an exemplary embodiment of the present disclosure includes: an array receiver including antenna elements that are arrayed; and a lens that refracts electromagnetic waves that are incident, the lens being configured to irradiate the array receiver. The array receiver is configured to weight the antenna elements with complex amplitudes at which the electromagnetic waves before being refracted by the lens are incident on the lens as a plane wave from a desired direction, and is configured to combine wavefronts of the electromagnetic waves after being refracted by the lens.

A beamforming method according to an exemplary embodiment of the present disclosure is performed by an antenna device including an array receiver and a lens, the array receiver including antenna elements that are arrayed. The beamforming method includes: weighting, by the array receiver, the antenna elements with complex amplitudes at which electromagnetic waves before being refracted by the lens are incident on the lens as a plane wave from a desired direction, to combine wavefronts of the electromagnetic waves after being refracted by the lens.

The configuration described above allows the array receiver to combine the wavefronts of the electromagnetic waves after being refracted by the lens by weighting the antenna elements with the complex amplitudes at which the incoming electromagnetic waves before being refracted by the lens are incident on the lens as a plane wave from a desired direction. As a result, beam shaping is performed so that power to be incident falls within the lens. The beam shaping enables improving aperture efficiency and suppressing incidence from the outside of the lens, and thus enabling improvement in degree of freedom in designing a wavefront to be synthesized by the array receiver in a combination of the lens and the array receiver.

An antenna device according to an exemplary embodiment of the present disclosure includes: an array receiver including antenna elements that are arrayed; and a reflector that reflects electromagnetic waves that are incident, the reflector being configured to irradiate the array receiver. The array receiver is configured to weight the antenna elements with complex amplitudes at which the electromagnetic waves before being reflected by the reflector are incident on the reflector as a plane wave from a desired direction, and is configured to combine wavefronts of the electromagnetic waves after being reflected by the reflector.

A beamforming method according to an exemplary embodiment of the present disclosure is performed by an antenna device including an array receiver and a reflector, the array receiver including antenna elements that are arrayed. The beamforming method includes: weighting, by the array receiver, the antenna elements with complex amplitudes at which electromagnetic waves before being reflected by the reflector are incident on the reflector as a plane wave from a desired direction, to combine wavefronts of the electromagnetic waves after being reflected by the reflector.

The configuration described above allows the array receiver to combine the wavefronts of the electromagnetic waves after being reflected by the reflector by weighting the multiple antenna elements with the complex amplitudes at which the incoming electromagnetic waves before being reflected by the reflector are incident on the reflector as a plane wave from a desired direction. As a result, beam shaping is performed so that power to be incident falls within the reflector. The beam shaping enables improving aperture efficiency and suppressing incidence from the outside of the reflector, and thus enabling improvement in degree of freedom in designing a wavefront to be synthesized by the array receiver in a combination of the reflector and the array receiver.

The present disclosure can be applied not only to the beamforming technology in the HAPS but also to the beamforming technology in wireless transmission.

What is claimed is:

1. An antenna device comprising:
an array feeder including antenna elements that are arrayed, the antenna elements being configured to radiate electromagnetic waves; and
a lens that refracts the electromagnetic waves,
wherein the array feeder is configured to excite the antenna elements with complex excitation amplitudes at which the electromagnetic waves after being refracted by the lens travel as a plane wave in a desired direction, each of the antenna elements being excited with a corresponding one of the complex excitation amplitudes.

2. The antenna device according to claim 1, further comprising a controller which, in operation, determines the complex excitation amplitudes based on conversion characteristics of the lens or based on desired wavefront characteristics at an incident surface of the lens, the conversion characteristics or the desired wavefront characteristics being calculated or measured in advance,
wherein the controller, in operation, controls the array feeder to excite the antenna elements with the complex excitation amplitudes.

3. The antenna device according to claim 1, wherein the array feeder is disposed at a position displaced from a focal plane of the lens.

4. An antenna device comprising:
an array receiver including antenna elements that are arrayed; and
a lens that refracts electromagnetic waves that are incident, the lens being configured to irradiate the array receiver,
wherein the array receiver is configured to weight the antenna elements with complex amplitudes at which the electromagnetic waves before being refracted by the lens are incident on the lens as a plane wave from a desired direction, and is configured to combine wavefronts of the electromagnetic waves after being refracted by the lens.

5. An antenna device comprising:
an array feeder including antenna elements that are arrayed, the antenna elements being configured to radiate electromagnetic waves; and
a reflector that reflects the electromagnetic waves,
wherein the array feeder is configured to excite the antenna elements with complex excitation amplitudes at which the electromagnetic waves after being reflected by the reflector travel as a plane wave in a desired direction.

6. An antenna device comprising:
an array receiver including antenna elements that are arrayed; and
a reflector that reflects electromagnetic waves that are incident, the reflector being configured to irradiate the array receiver,
wherein the array receiver is configured to weight the antenna elements with complex amplitudes at which the electromagnetic waves before being reflected by the reflector are incident on the reflector as a plane wave from a desired direction, and is configured to combine wavefronts of the electromagnetic waves after being reflected by the reflector.

7. A beamforming method performed by an antenna device including an array feeder and a lens, the array feeder including antenna elements that are arrayed, the beamforming method comprising:
exciting, by the array feeder, the antenna elements to radiate electromagnetic waves from the antenna elements, wherein the exciting includes exciting the antenna elements with complex excitation amplitudes at which the electromagnetic waves after being refracted by the lens travel as a plane wave in a desired direction.

8. A beamforming method performed by an antenna device including an array receiver and a lens, the array receiver including antenna elements that are arrayed, the beamforming method comprising:
weighting, by the array receiver, the antenna elements with complex amplitudes at which electromagnetic waves before being refracted by the lens are incident on the lens as a plane wave from a desired direction, to combine wavefronts of the electromagnetic waves after being refracted by the lens.

9. A beamforming method performed by an antenna device including an array feeder and a reflector, the array feeder including antenna elements that are arrayed, the beamforming method comprising:
exciting, by the array feeder, the antenna elements to radiate electromagnetic waves from the antenna elements, wherein the exciting includes exciting the antenna elements with complex excitation amplitudes at which the electromagnetic waves after being reflected by the reflector travel as a plane wave in a desired direction.

10. A beamforming method performed by an antenna device including an array receiver and a reflector, the array receiver including antenna elements that are arrayed, the beamforming method comprising:
weighting, by the array receiver, the antenna elements with complex amplitudes at which electromagnetic waves before being reflected by the reflector are incident on the reflector as a plane wave from a desired direction, to combine wavefronts of the electromagnetic waves after being reflected by the reflector.

11. A non-transitory computer readable storage medium for causing a controller included in an antenna device to execute the beamforming method according to claim 7.

12. A non-transitory computer readable storage medium for causing a controller included in an antenna device to execute the beamforming method according to claim 8.

13. A non-transitory computer readable storage medium for causing a controller included in an antenna device to execute the beamforming method according to claim 9.

14. A non-transitory computer readable storage medium for causing a controller included in an antenna device to execute the beamforming method according to claim 10.
